(19) United States
(12) Patent Application Publication
(10) Pub. No.: US 2024/0361497 A1
(43) Pub. Date: Oct. 31, 2024

(54) HYBRID LENS AND CASTING METHOD

(71) Applicant: Meta Platforms Technologies, LLC, Menlo Park, CA (US)

(72) Inventors: Sho Nakahara, Bothell, WA (US); Rongzhi Huang, Sammamish, WA (US); Carl Chancy, Seattle, WA (US)

(21) Appl. No.: 18/537,403

(22) Filed: Dec. 12, 2023

Related U.S. Application Data
(60) Provisional application No. 63/499,010, filed on Apr. 28, 2023.

(51) Int. Cl. G02B 1/04; G02B 27/01

(52) U.S. Cl. CPC G02B 1/041; G02B 27/0172

(57) ABSTRACT

A hybrid lens includes a primary lens element having a pair of opposing optical surfaces and a secondary lens element disposed directly over at least one of the optical surfaces. The primary lens element may include a 3D-printed layer, and the secondary lens element may be over-formed by casting. An electronic component such as a dimming component, a waveguide component, or an eye-tracking component may be integrated into the hybrid lens.

### CROSS-REFERENCE TO RELATED APPLICATION

This application claims the benefit of priority under 35 U.S.C. § 119(e) of U.S. Provisional Application No. 63/499,010, filed Apr. 28, 2023, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a schematic cross-sectional view of a hybrid lens according to some embodiments.

FIG. 2 illustrates of method of manufacturing the hybrid lens of FIG. 1 according to some embodiments.

FIG. 3 is a schematic cross-sectional view of a hybrid lens with an integrated electronic component according to some embodiments.

FIG. 4 illustrates a method of manufacturing the hybrid lens of FIG. 3 according to some embodiments.

FIG. 5 illustrates a casting method for forming a hybrid plano-concave lens according to some embodiments.

FIG. 6 illustrates a casting method for forming a hybrid plano-convex lens according to some embodiments.

FIG. 7 illustrates a method for forming a hybrid lens according to still further embodiments.

FIG. 8 illustrates a casting method for forming a composite hybrid lens according to certain embodiments.

FIG. 9 is an illustration of exemplary augmented-reality glasses that may be used in connection with embodiments of this disclosure.

FIG. 10 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

A hybrid lens includes a glass lens element and a polymer lens element disposed over the glass lens element. The hybrid lens may have a plano-concave architecture or a plano-convex architecture, for example, and may include a planar glass element and an over-formed polymer lens element having a curved outer surface. In accordance with various embodiments, the polymer lens element may be formed by three-dimensional printing or casting. A polymer lens element may be formed over one or both major surfaces of the glass lens element.

A hybrid lens according to some embodiments includes a plano-concave lens element formed from a high refractive index material and a meniscus lens element formed from a low refractive index material, where the meniscus lens element directly overlies a concave optical surface of the plano-concave lens element. An electronic component such as a dimming component, a waveguide component, or an eye-tracking component may be directly integrated into the hybrid lens.

A further example hybrid lens includes a plano-concave lens element having negative optical power and a meniscus lens element having positive optical power, where the meniscus lens element overlies a concave portion of the plano-concave lens element.

Still further hybrid lenses include a planar lens element and an over-formed lens element having a concave or a convex outer surface. The planar lens element may include a layer of functional glass and the over-formed lens element may include a printed or cast polymer layer.

A method of manufacturing a hybrid lens includes forming a plano-concave lens element including a high refractive index material and forming a meniscus lens element including a low refractive index material over a concave optical surface of the plano-concave lens element. The method may additionally include forming an electronic component and encapsulating the electronic component within the plano-concave lens element while forming the plano-concave lens element.

A further method of manufacturing a hybrid lens includes placing a glass lens element into a mold and casting a polymer lens element over at least one major optical surface of the glass lens element.

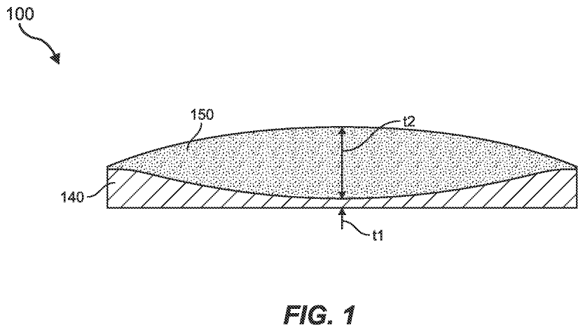

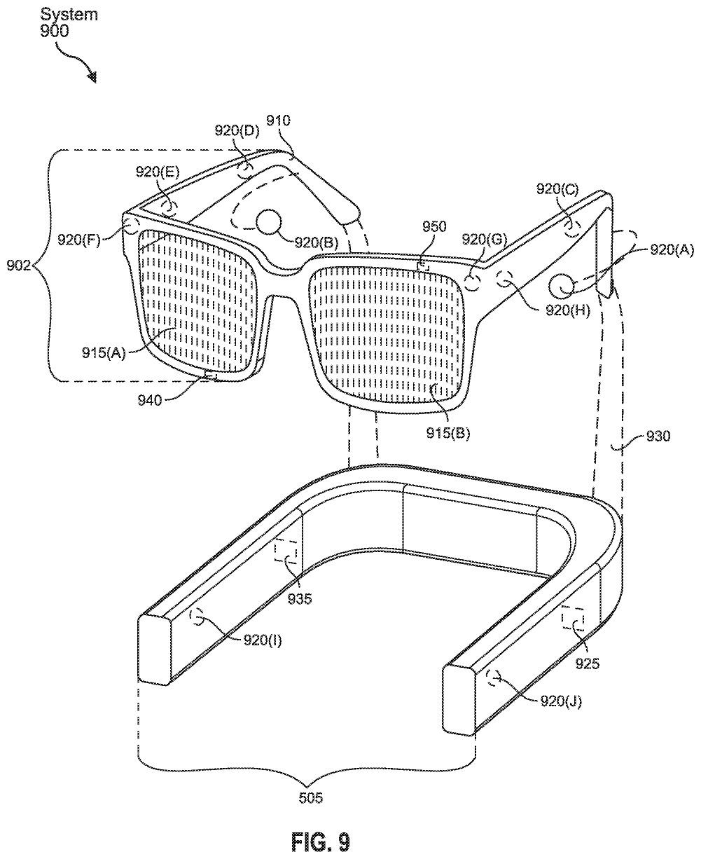

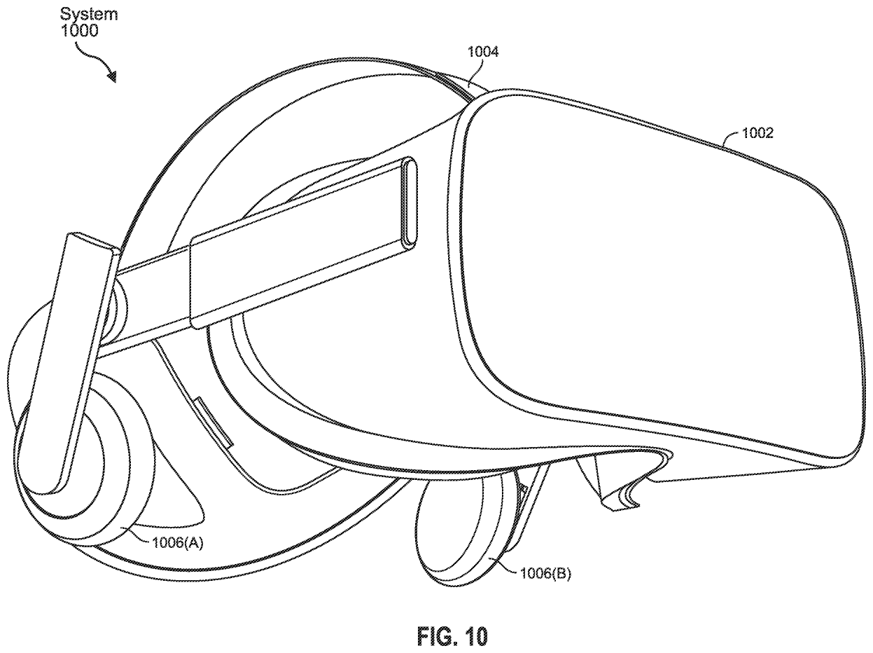

The following will provide, with reference to FIGS. 1-10, detailed descriptions of methods for optical system manufacture and associated hybrid lens architectures. The discussion associated with FIGS. 1-8 includes a description of hybrid lens architectures and associated methods of manufacture. The discussion associated with FIGS. 9 and 10 relates to exemplary virtual reality and augmented reality devices that may include a hybrid lens as disclosed herein.

Referring to FIG. 1, shown is a cross-sectional schematic view of an example hybrid plano-convex lens. Lens 100 includes a high refractive index plano-concave lens element 140 and a low refractive index meniscus lens element 150 overlying the concave optical surface of the plano-concave lens element. The plano-concave lens element 140 may have negative optical power and the meniscus lens element 150 may have positive optical power.

A minimum thickness, e.g., a center thickness t1, of the plano-concave lens element 140 may range from approximately 50 micrometers to approximately 500 micrometers. A maximum thickness, e.g., a center thickness t2, of the meniscus lens element may range from approximately 1 mm to approximately 10 millimeters.

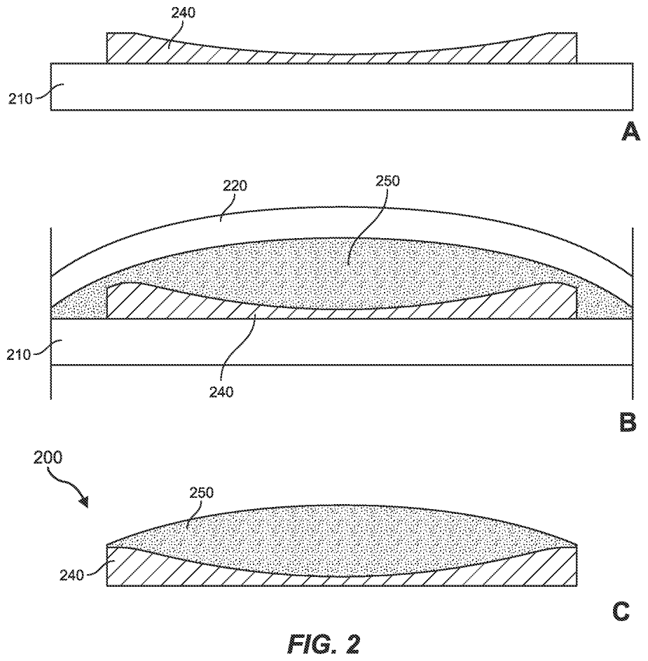

In certain embodiments, the high refractive index material forming the plano-concave lens element 140 may include an acrylate, a thio acrylate, or a polyurethane methacrylate and may have a refractive index ranging from approximately 1.53 to approximately 1.70. In some embodiments, the low refractive index material forming the meniscus lens element may include a poly(allyl diglycol carbonate), polyurethane methacrylate, epoxy, or polyamide and may have a refractive index ranging from approximately 1.45 to approximately 1.52. An example method of manufacturing hybrid plano-convex lens 100 is shown in FIG. 2.

Referring to FIG. 2A, a plano-concave lens element 240 may be formed over a substrate 210. Substrate 210 may include a glass substrate, for example. In certain embodiments, plano-concave lens element 240 may be formed by 3D printing. Thereafter, and with reference to FIG. 2B, a mold element 220 may be disposed over the intermediate structure of FIG. 2A, and a suitable resin may be introduced into the mold element 220 to form a meniscus lens element 250 overlying the concave optical surface of plano-concave lens element 240. In some embodiments, meniscus lens element 250 may be molded directly over plano-concave lens element 240. Referring to FIG. 2C, hybrid plano-convex lens 200 may be removed from the mold element 220 and separated from the substrate 210 to form a free-standing lens.

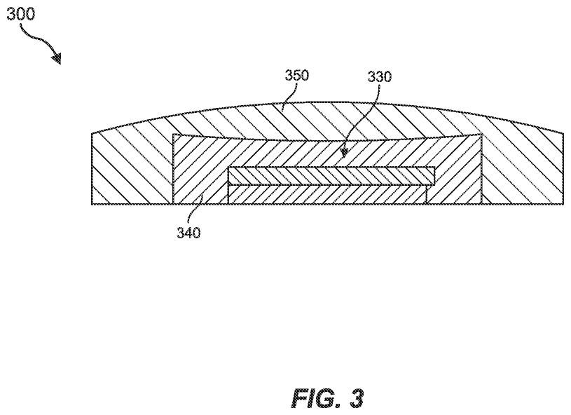

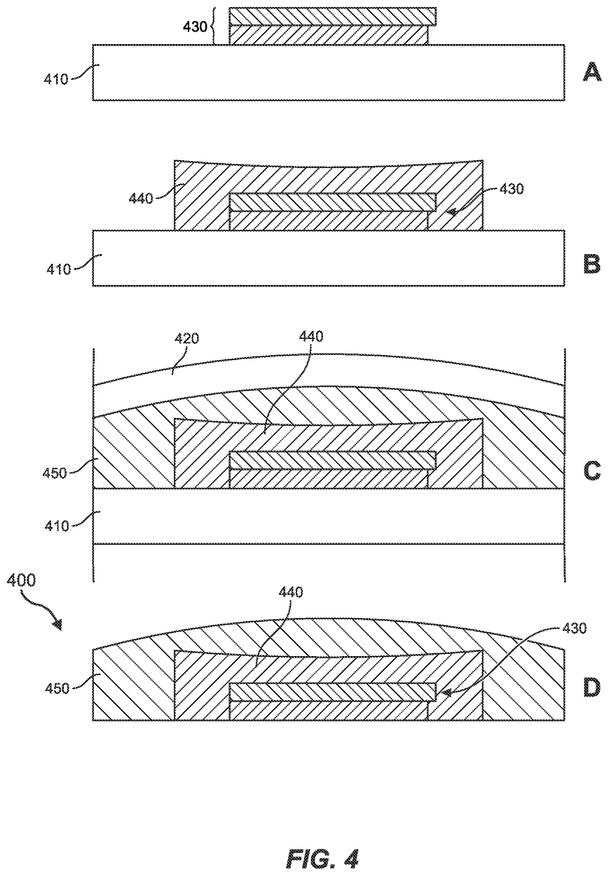

Turning now to FIG. 3, shown is a cross-sectional schematic view of an example hybrid plano-convex lens having a co-integrated electronic component. Hybrid lens 300 includes a high refractive index plano-concave lens element 340 and a low refractive index meniscus lens element 350 overlying the concave optical surface of the plano-concave lens element. An electronic component 330 may be embedded within the high refractive index plano-concave lens element 340. In particular embodiments, the electronic component 330 may have a planar or substantially planar form factor. An example method of manufacturing hybrid plano-convex lens 300 is shown in FIG. 4.

Referring to FIG. 4A, an electronic component 430 may be formed over a substrate 410. Thereafter, as shown in FIG. 4B, a plano-concave lens element 440 may be formed over the substrate 410 and in a manner to encapsulate electronic component 430. Plano-concave lens element 440 may be formed by 3D printing. With reference to FIG. 4C, a mold 420 may be disposed over the structure of FIG. 4B, and a resin may be introduced into the mold 420 to form a meniscus lens element 450 overlying the concave optical surface of plano-concave lens element 440. In some embodiments, meniscus lens element 450 may be molded directly over plano-concave lens element 440. Referring to FIG. 4D, hybrid plano-convex lens 400 may be separated from the substrate 410 and removed from the mold 420 to form a free-standing lens including a co-integrated electronic component 430.

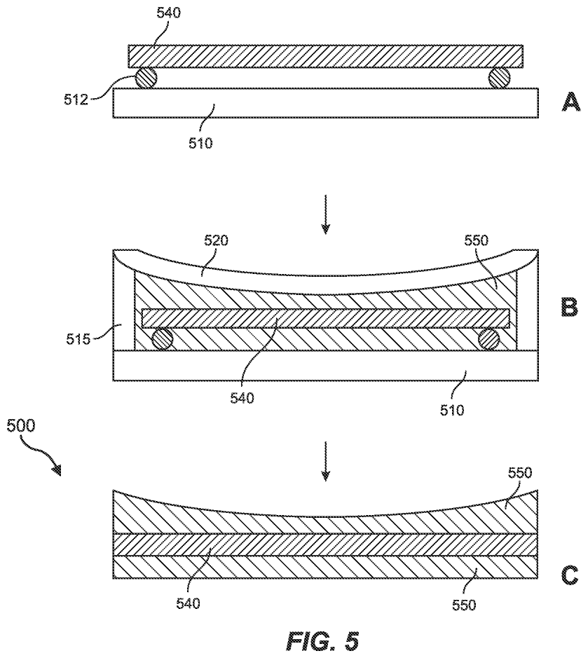

Referring to FIG. 5, illustrated is a further method for manufacturing a hybrid lens. As shown in FIG. 5A, a functional glass element 540 may be disposed over a substrate 510 and supported by support elements 512. Functional glass element 540 may include waveguide glass, eye-tracking glass, active dimming glass, or other functional glass. Substrate 510 may include a portion of a mold, for example, and the method may include casting.

As shown in FIG. 5B, side mold elements 515 and top mold element 520 may be arranged to encapsulate the functional glass element 540. As shown in the illustrated embodiment, an interior surface of the top mold element 520 may be convex. A suitable resin 550 may be injected into the mold and directly over the functional glass element 540. That is, a resinous layer formed from resin 550 may be formed over the functional glass element without an intervening adhesion layer. With reference to FIG. 5C, following polymerization or curing of the resin, hybrid lens 500 may be removed from the mold 510, 515, 520 and may include a plano-concave architecture.

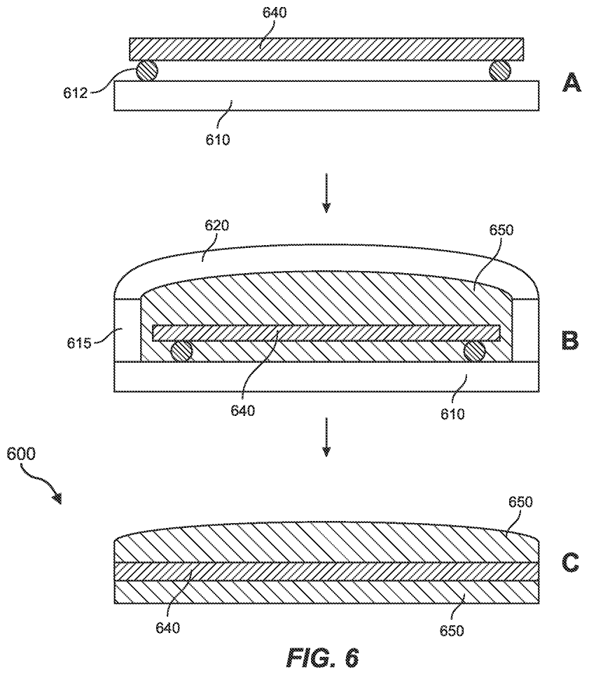

Referring to FIG. 6, illustrated is a still further method for manufacturing a hybrid lens. As shown in FIG. 6A, a functional glass element 640 may be disposed over a substrate 610 and supported by support elements 612. Functional glass element 640 may include waveguide glass, eye-tracking glass, active dimming glass, or other functional glass. Substrate 610 may include a portion of a mold, and the method may include casting.

As shown in FIG. 6B, side mold elements 615 and top mold element 620 may be arranged to encapsulate the functional glass element 640. An interior surface of the top mold element 620 may be concave. A suitable resin 650 may be injected into the mold and directly over the functional glass element 640 such that a resinous layer formed from resin 650 is formed over the functional glass element without an intervening adhesion layer. With reference to FIG. 6C, following polymerization or curing of the resin, hybrid lens 600 may be removed from the mold 610, 615, 620 and may include a plano-convex architecture.

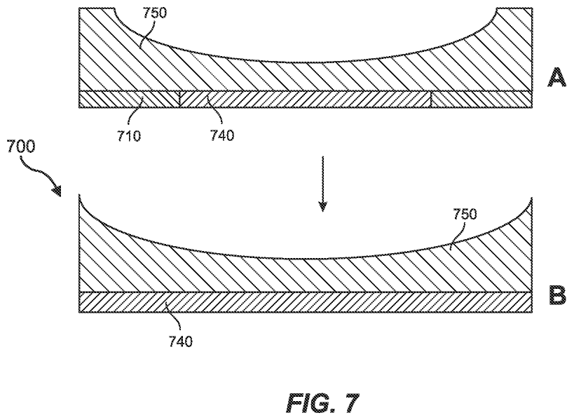

Referring to FIG. 7, hybrid lens 700 may include a functional glass element 740 and a plano-concave lens element 750 formed directly over the functional glass element 740. Referring to FIG. 7A, functional glass element 740 may be supported by a chuck 710 or other suitable substrate. Resin layer 750 may be formed directly over the functional glass element 740, such as by 3D printing. Additive and/or subtractive processing, such as etching, may be used to form an ultra-thin resin layer 750 directly over a region of the functional glass element, as shown in FIG. 7B. In the illustrated embodiments, a center thickness of the plano-concave lens element 700 may range from approximately 50 micrometers to approximately 500 micrometers.

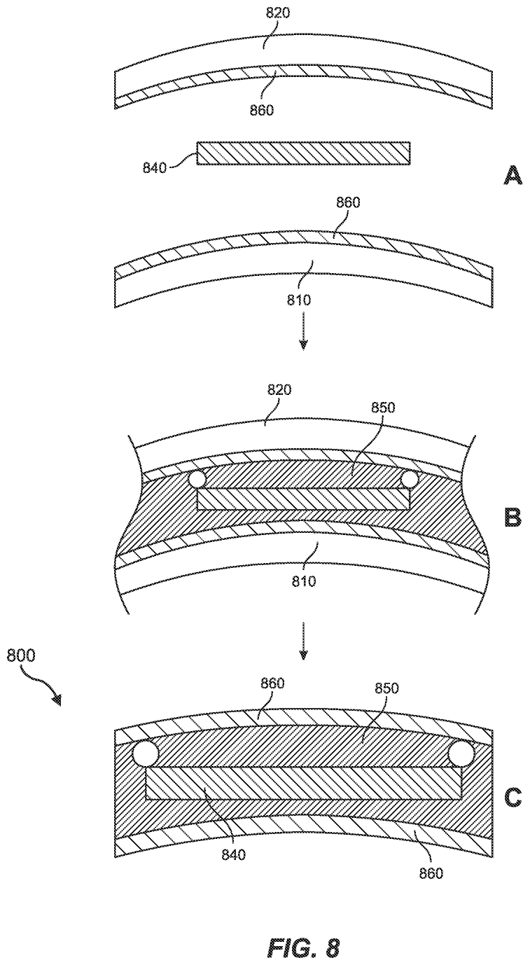

Turning to FIG. 8, illustrated is a further method for manufacturing a hybrid lens. In the method of FIG. 8, and referring initially to FIG. 8A, lower and upper mold elements 810, 820 may be arranged to encapsulate a functional glass element 840. A transfer coating 860 may be formed over the inner surface of one or both of the mold elements.

Referring to FIG. 8B, mold elements 810, 820 may encapsulate functional glass element and a suitable resin 850 may be injected into the mold and directly over the functional glass element 840. During the casting process, such as during polymerization or curing of the resin 850, transfer coatings 860 may bond with the resin. Following polymerization or curing of the resin, hybrid lens 800 may be removed from the mold and may include functional glass element 840, an organic (resinous) lens element 850 bonded directly to the functional glass element 840, and a transfer coating 860 disposed over one or both major surfaces of the organic (resinous) lens element 850. In accordance with some embodiments, a transfer coating may include an anti-reflective coating, a polarizing coating, etc. As will be appreciated, the over-molding method depicted in FIG. 8 may be a low cost and high yield method of manufacturing hybrid lens 800.

A hybrid lens, such as a plano-convex lens, includes a high refractive index plano-concave lens element and a low refractive index meniscus lens element overlying the concave surface of the high refractive index plano-concave lens element. Independently, the plano-concave lens element may have negative optical power (e.g., approximately −1.0 D to approximately 0 D, and cylinder up to approximately +1.0 D) and the meniscus lens element may have positive optical power (e.g., approximately +0.5 D to approximately +2.5 D, and cylinder up to approximately +2.0 D). In some embodiments, an optical power of the hybrid plano-convex lens may range from approximately +0.5 D to approximately +1.5 D, with cylinder up to approximately +1.0 D. The plano-concave lens element may be 3D printed and the meniscus lens element may be cast directly over the concave surface of the plano-concave lens element using a suitable resin.

A refractive index of the plano-concave lens element may range from approximately 1.53 to 1.70, for example, whereas a refractive index of the meniscus lens element may be less than the refractive index of the plano-concave lens element and may range from approximately 1.45-1.52. In some embodiments, an optical component such as a dimming component, waveguide component, or eye-tracking component, and the like may be co-integrated into the hybrid lens by initially forming the optical component and encapsulating the optical component with the plano-concave lens element, i.e., during an act of 3D printing. A total thickness of the hybrid plano-convex lens may be less than that of comparative lenses.

### Example Embodiments

Example 1: A hybrid lens includes a primary lens element having a pair of opposing optical surfaces, and a secondary lens element disposed directly over at least one of the optical surfaces.

Example 2: The hybrid lens of Example 1, where the primary lens element includes an inorganic layer and the secondary lens element includes an organic layer.

Example 3: The hybrid lens of any of Examples 1 and 2, where the primary lens element includes a 3D-printed layer.

Example 4: The hybrid lens of any of Examples 1-3, where the primary lens element has a first refractive index and the secondary lens element has a second refractive index different than the first refractive index.

Example 5: The hybrid lens of any of Examples 1-3, where the primary lens element includes a layer of functional glass.

Example 6: The hybrid lens of Example 5, where the functional glass includes an electronic component selected from a waveguide, a dimming module, and an eye-tracking module.

Example 7: The hybrid lens of any of Examples 1-6, where the primary lens element includes a layer of functional glass having an over-formed 3D-printed layer.

Example 8: The hybrid lens of any of Examples 1-7, where the secondary lens element is disposed over the pair of opposing optical surfaces.

Example 9: The hybrid lens of any of Examples 1-8, where the secondary lens element fully encapsulates the primary lens element.

Example 10: A method includes forming a primary lens element including a high refractive index material, and forming a secondary lens element including a low refractive index material over an optical surface of the primary lens element.

Example 11: The method of Example 10, further including forming an electronic component and encapsulating the electronic component within the primary lens element while forming the secondary lens element.

Example 12: The method of any of Examples 10 and 11, where forming the primary lens element includes 3D printing.

Example 13: The method of any of Examples 10-12, where forming the secondary lens element includes casting in a mold.

Example 14: The method of Example 13, further including forming a coating over an inner surface of the mold and transferring the coating to an outer surface of the secondary lens element during the casting.

Example 15: A hybrid lens includes a plano-concave lens element including a high refractive index material, and a meniscus lens element including a low refractive index material, where the meniscus lens element directly overlies a concave surface of the plano-concave lens element.

Example 16: The hybrid lens of Example 15, where a minimum thickness of the plano-concave lens element ranges from approximately 50 micrometers to approximately 500 micrometers.

Example 17: The hybrid lens of any of Examples 15 and 16, where a center thickness of the plano-concave lens element ranges from approximately 50 micrometers to approximately 500 micrometers.

Example 18: The hybrid lens of any of Examples 15-17, where a maximum thickness of the hybrid plano-convex lens element ranges from approximately 1 mm to approximately 10 mm.

Example 19: The hybrid lens of any of Examples 15-18, where a center thickness of the meniscus lens element ranges from approximately 500 micrometers to approximately 9 mm.

Example 20: The hybrid lens of any of Examples 15-19, where the high refractive index material has a refractive index ranging from approximately 1.53 to approximately 1.70, and the low refractive index material has a refractive index ranging from approximately 1.45 to approximately 1.52.

Example 21: The hybrid lens of any of Examples 15-20, where the high refractive index material includes a polymer selected from an acrylate, a thio acrylate, and a polyurethane methacrylate.

Example 22: The hybrid lens of any of Examples 15-21, where the low refractive index material includes a polymer selected from poly(allyl diglycol carbonate), polyurethane methacrylate, epoxy, and polyamide.

Example 23: The hybrid lens of any of Examples 15-22, where the plano-concave lens element has negative optical power.

Example 24: The hybrid lens of any of Examples 15-23, where the meniscus lens element has positive optical power.

Example 25: The hybrid lens of any of Examples 15-23, where the meniscus lens element has negative optical power.

Example 26: The hybrid lens of any of Examples 15-25, where an optical power of the hybrid lens ranges from approximately +0.5 D to approximately +1.5 D.

Example 27: The hybrid lens of any of Examples 15-26, further including an electronic component embedded within the plano-concave lens element.

Example 28: The hybrid lens of Example 27, where the electronic component is selected from a waveguide, a dimming module, and an eye-tracking module.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (e.g., augmented-reality system 900 in FIG. 9) or that visually immerses a user in an artificial reality (e.g., virtual-reality system 1000 in FIG. 10). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 9, augmented-reality system 900 may include an eyewear device 902 with a frame 910 configured to hold a left display device 915(A) and a right display device 915(B) in front of a user's eyes. Display devices 915(A) and 915(B) may act together or independently to present an image or series of images to a user. While augmented-reality system 900 includes two displays, embodiments of this disclosure may be implemented in augmented-reality systems with a single NED or more than two NEDs.

In some embodiments, augmented-reality system 900 may include one or more sensors, such as sensor 940. Sensor 940 may generate measurement signals in response to motion of augmented-reality system 900 and may be located on substantially any portion of frame 910. Sensor 940 may represent a position sensor, an inertial measurement unit (IMU), a depth camera assembly, a structured light emitter and/or detector, or any combination thereof. In some embodiments, augmented-reality system 900 may or may not include sensor 940 or may include more than one sensor. In embodiments in which sensor 940 includes an IMU, the IMU may generate calibration data based on measurement signals from sensor 940. Examples of sensor 940 may include, without limitation, accelerometers, gyroscopes, magnetometers, other suitable types of sensors that detect motion, sensors used for error correction of the IMU, or some combination thereof.

Augmented-reality system 900 may also include a microphone array with a plurality of acoustic transducers 920(A)-920(J), referred to collectively as acoustic transducers 920. Acoustic transducers 920 may be transducers that detect air pressure variations induced by sound waves. Each acoustic transducer 920 may be configured to detect sound and convert the detected sound into an electronic format (e.g., an analog or digital format). The microphone array in FIG. 9 may include, for example, ten acoustic transducers: 920(A) and 920(B), which may be designed to be placed inside a corresponding ear of the user, acoustic transducers 920(C), 920(D), 920(E), 920(F), 920(G), and 920(H), which may be positioned at various locations on frame 910, and/or acoustic transducers 920(I) and 920(J), which may be positioned on a corresponding neckband 905.

In some embodiments, one or more of acoustic transducers 920(A)-(F) may be used as output transducers (e.g., speakers). For example, acoustic transducers 920(A) and/or 920(B) may be earbuds or any other suitable type of headphone or speaker.

The configuration of acoustic transducers 920 of the microphone array may vary. While augmented-reality system 900 is shown in FIG. 9 as having ten acoustic transducers 920, the number of acoustic transducers 920 may be greater or less than ten. In some embodiments, using higher numbers of acoustic transducers 920 may increase the amount of audio information collected and/or the sensitivity and accuracy of the audio information. In contrast, using a lower number of acoustic transducers 920 may decrease the computing power required by an associated controller 950 to process the collected audio information. In addition, the position of each acoustic transducer 920 of the microphone array may vary. For example, the position of an acoustic transducer 920 may include a defined position on the user, a defined coordinate on frame 910, an orientation associated with each acoustic transducer 920, or some combination thereof.

Acoustic transducers 920(A) and 920(B) may be positioned on different parts of the user's ear, such as behind the pinna, behind the tragus, and/or within the auricle or fossa. Or, there may be additional acoustic transducers 920 on or surrounding the ear in addition to acoustic transducers 920 inside the ear canal. Having an acoustic transducer 920 positioned next to an ear canal of a user may enable the microphone array to collect information on how sounds arrive at the ear canal. By positioning at least two of acoustic transducers 920 on either side of a user's head (e.g., as binaural microphones), augmented-reality device 900 may simulate binaural hearing and capture a 3D stereo sound field around about a user's head. In some embodiments, acoustic transducers 920(A) and 920(B) may be connected to augmented-reality system 900 via a wired connection 930, and in other embodiments acoustic transducers 920(A) and 920(B) may be connected to augmented-reality system 900 via a wireless connection (e.g., a Bluetooth connection). In still other embodiments, acoustic transducers 920(A) and 920(B) may not be used at all in conjunction with augmented-reality system 900.

Acoustic transducers 920 on frame 910 may be positioned along the length of the temples, across the bridge, above or below display devices 915(A) and 915(B), or some combination thereof. Acoustic transducers 920 may be oriented such that the microphone array is able to detect sounds in a wide range of directions surrounding the user wearing the augmented-reality system 900. In some embodiments, an optimization process may be performed during manufacturing of augmented-reality system 900 to determine relative positioning of each acoustic transducer 920 in the microphone array.

In some examples, augmented-reality system 900 may include or be connected to an external device (e.g., a paired device), such as neckband 905. Neckband 905 generally represents any type or form of paired device. Thus, the following discussion of neckband 905 may also apply to various other paired devices, such as charging cases, smart watches, smart phones, wrist bands, other wearable devices, hand-held controllers, tablet computers, laptop computers, other external compute devices, etc.

As shown, neckband 905 may be coupled to eyewear device 902 via one or more connectors. The connectors may be wired or wireless and may include electrical and/or non-electrical (e.g., structural) components. In some cases, eyewear device 902 and neckband 905 may operate independently without any wired or wireless connection between them. While FIG. 9 illustrates the components of eyewear device 902 and neckband 905 in example locations on eyewear device 902 and neckband 905, the components may be located elsewhere and/or distributed differently on eyewear device 902 and/or neckband 905. In some embodiments, the components of eyewear device 902 and neckband 905 may be located on one or more additional peripheral devices paired with eyewear device 902, neckband 905, or some combination thereof.

Pairing external devices, such as neckband 905, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 900 may be provided by a paired device or shared between a paired device and an eyewear device, thus reducing the weight, heat profile, and form factor of the eyewear device overall while still retaining desired functionality. For example, neckband 905 may allow components that would otherwise be included on an eyewear device to be included in neckband 905 since users may tolerate a heavier weight load on their shoulders than they would tolerate on their heads. Neckband 905 may also have a larger surface area over which to diffuse and disperse heat to the ambient environment. Thus, neckband 905 may allow for greater battery and computation capacity than might otherwise have been possible on a stand-alone eyewear device. Since weight carried in neckband 905 may be less invasive to a user than weight carried in eyewear device 902, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 905 may be communicatively coupled with eyewear device 902 and/or to other devices. These other devices may provide certain functions (e.g., tracking, localizing, depth mapping, processing, storage, etc.) to augmented-reality system 900. In the embodiment of FIG. 9, neckband 905 may include two acoustic transducers (e.g., 920(I) and 920(J)) that are part of the microphone array (or potentially form their own microphone subarray). Neckband 905 may also include a controller 925 and a power source 935.

Acoustic transducers 920(I) and 920(J) of neckband 905 may be configured to detect sound and convert the detected sound into an electronic format (analog or digital). In the embodiment of FIG. 9, acoustic transducers 920(I) and 920(J) may be positioned on neckband 905, thereby increasing the distance between the neckband acoustic transducers 920(I) and 920(J) and other acoustic transducers 920 positioned on eyewear device 902. In some cases, increasing the distance between acoustic transducers 920 of the microphone array may improve the accuracy of beamforming performed via the microphone array. For example, if a sound is detected by acoustic transducers 920(C) and 920(D) and the distance between acoustic transducers 920(C) and 920(D) is greater than, e.g., the distance between acoustic transducers 920(D) and 920(E), the determined source location of the detected sound may be more accurate than if the sound had been detected by acoustic transducers 920(D) and 920(E).

Controller 925 of neckband 905 may process information generated by the sensors on neckband 905 and/or augmented-reality system 900. For example, controller 925 may process information from the microphone array that describes sounds detected by the microphone array. For each detected sound, controller 925 may perform a direction-of-arrival (DOA) estimation to estimate a direction from which the detected sound arrived at the microphone array. As the microphone array detects sounds, controller 925 may populate an audio data set with the information. In embodiments in which augmented-reality system 900 includes an inertial measurement unit, controller 925 may compute all inertial and spatial calculations from the IMU located on eyewear device 902. A connector may convey information between augmented-reality system 900 and neckband 905 and between augmented-reality system 900 and controller 925. The information may be in the form of optical data, electrical data, wireless data, or any other transmittable data form. Moving the processing of information generated by augmented-reality system 900 to neckband 905 may reduce weight and heat in eyewear device 902, making it more comfortable to the user.

Power source 935 in neckband 905 may provide power to eyewear device 902 and/or to neckband 905. Power source 935 may include, without limitation, lithium ion batteries, lithium-polymer batteries, primary lithium batteries, alkaline batteries, or any other form of power storage. In some cases, power source 935 may be a wired power source. Including power source 935 on neckband 905 instead of on eyewear device 902 may help better distribute the weight and heat generated by power source 935.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1000 in FIG. 10, that mostly or completely covers a user's field of view. Virtual-reality system 1000 may include a front rigid body 1002 and a band 1004 shaped to fit around a user's head. Virtual-reality system 1000 may also include output audio transducers 1006(A) and 1006(B). Furthermore, while not shown in FIG. 10, front rigid body 1002 may include one or more electronic elements, including one or more electronic displays, one or more inertial measurement units (IMUs), one or more tracking emitters or detectors, and/or any other suitable device or system for creating an artificial reality experience.

Artificial-reality systems may include a variety of types of visual feedback mechanisms. For example, display devices in augmented-reality system 900 and/or virtual-reality system 1000 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some artificial-reality systems may include one or more projection systems. For example, display devices in augmented-reality system 900 and/or virtual-reality system 1000 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

Artificial-reality systems may also include various types of computer vision components and subsystems. For example, augmented-reality system 900 and/or virtual-reality system 1000 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIG. 10, output audio transducers 1006(A) and 1006(B) may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

While not shown in FIG. 9, artificial-reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a lens element that comprises or includes polycarbonate include embodiments where a lens element consists essentially of polycarbonate and embodiments where a lens element consists of polycarbonate.

What is claimed is:

1. A hybrid lens comprising:
a primary lens element having a pair of opposing optical surfaces; and
a secondary lens element disposed directly over at least one of the optical surfaces.

2. The hybrid lens of claim 1, wherein the primary lens element comprises an inorganic layer and the secondary lens element comprises an organic layer.

3. The hybrid lens of claim 1, wherein the primary lens element comprises a 3D-printed layer.

4. The hybrid lens of claim 1, wherein the primary lens element has a first refractive index and the secondary lens element has a second refractive index different than the first refractive index.

5. The hybrid lens of claim 1, wherein the primary lens element comprises a layer of functional glass.

6. The hybrid lens of claim 5, wherein the functional glass comprises an electronic component selected from the group consisting of a waveguide, a dimming module, and an eye-tracking module.

7. The hybrid lens of claim 1, wherein the primary lens element comprises a layer of functional glass and an over-formed 3D-printed layer.

8. They hybrid lens of claim 1, wherein the secondary lens element is disposed over the pair of opposing optical surfaces.

9. The hybrid lens of claim 1, wherein the secondary lens element fully encapsulates the primary lens element.

10. A method comprising:
forming a primary lens element comprising a high refractive index material; and
forming a secondary lens element comprising a low refractive index material over an optical surface of the primary lens element.

11. The method of claim 10, further comprising forming an electronic component and encapsulating the electronic component within the primary lens element while forming the secondary lens element.

12. The method of claim 10, wherein forming the primary lens element comprises 3D printing.

13. The method of claim 10, wherein forming the secondary lens element comprises casting in a mold.

14. The method of claim 13, further comprising:
forming a coating over an inner surface of the mold; and
transferring the coating to an outer surface of the secondary lens element during the casting.

15. A hybrid lens comprising:
a plano-concave lens element comprising a high refractive index material; and
a meniscus lens element comprising a low refractive index material, wherein the meniscus lens element directly overlies a concave surface of the plano-concave lens element.

16. The hybrid lens of claim 15, wherein a minimum thickness of the plano-concave lens element ranges from approximately 50 micrometers to approximately 500 micrometers.

17. The hybrid lens of claim 15, wherein a center thickness of the plano-concave lens element ranges from approximately 50 micrometers to approximately 500 micrometers.

18. The hybrid lens of claim 15, wherein a maximum thickness of the hybrid plano-convex lens element ranges from approximately 1 mm to approximately 10 mm.

19. The hybrid lens of claim 15, wherein a center thickness of the meniscus lens element ranges from approximately 500 micrometers to approximately 9 mm.

20. They hybrid lens of claim 15, wherein the high refractive index material has a refractive index ranging from approximately 1.53 to approximately 1.70, and the low refractive index material has a refractive index ranging from approximately 1.45 to approximately 1.52.
